(19) United States
(12) Patent Application Publication
(10) Pub. No.: US 2009/0080182 A1
(43) Pub. Date: Mar. 26, 2009

(54) STREET LIGHT WITH WIND POWER GENERATOR

(76) Inventor: Hi Huang, Taipei (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/860,859

(22) Filed: Sep. 25, 2007

(51) Int. Cl. F21L 4/00

(52) U.S. Cl. 362/183

(57) ABSTRACT

A street light includes a post with a light bulb connected to a top thereof and a wind power generator unit is connected to the post and includes a shaft, a plurality of blades connected to the shaft, and a generator connected to the shaft. A chargeable battery is electrically connected to the generator and the light bulb. A circuit board is electrically connected to the chargeable battery and the light bulb.

### FIELD OF THE INVENTION

The present invention relates to a street light with a wind power generator which is connected to the post and provides electric power to the street light.

### BACKGROUND OF THE INVENTION

A conventional street light generally includes a post and a light bulb connected to a top of the post. The light bulb is connected with a circuit board and a chargeable battery is connected to the circuit board so as to power the light bulb. A solar power panel is connected on a top of the light bulb and transfers solar power to electric power which is stored in the chargeable battery. However, the solar power panel functions only on the daytime and the solar power might not be sufficient during winter time.

The present invention intends to provide a street light which is powered by a wind power generator which is cooperated with chargeable battery so as to provide power during nighttime.

### SUMMARY OF THE INVENTION

The present invention relates to a street light which comprises a post and a light bulb is connected to a top of the post. A wind power generator unit is connected to the post and includes a shaft, a plurality of blades connected to the shaft and a generator connected to the shaft. A chargeable battery is electrically connected to the generator and the light bulb. A circuit board is electrically connected to the chargeable battery and the light bulb.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the street light with a wind power generator of the present invention;

FIG. 2 is a partial cross sectional view of the street light with the wind power generator of the present invention;

FIG. 3 is a side view to show that a solar power panel is connected with the wind power generator;

FIG. 4 is a flow chart of the circuit of the circuit board of the present invention, and

FIG. 5 is a flow chart of the circuit of the MCU of the present invention.

### DETAILED DESCRIPTION OF THE PREFERRED EMBODIMENT

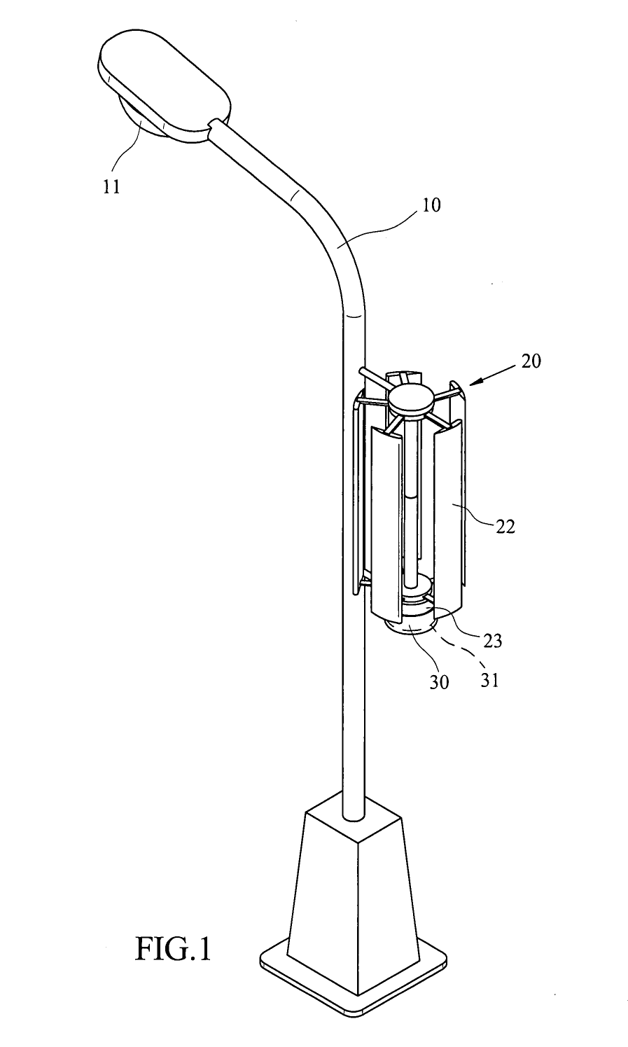

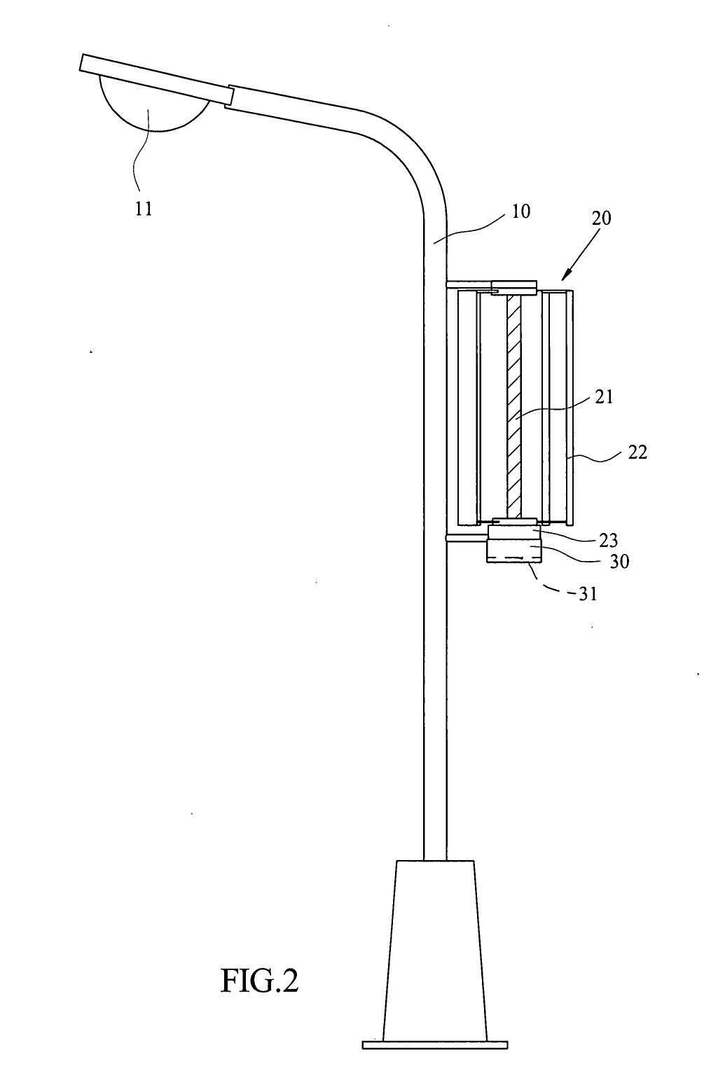

Referring to FIGS. 1 to 4, the street light of the present invention comprises a post 10 having a light bulb 11 connected to a top thereof and the light bulb 11 is composed of Light Emitting Diodes.

A wind power generator unit 20 is connected to the post 10 and includes an upright shaft 21, a plurality of blades 22 connected to the shaft 21 and a generator 23 connected to the shaft 21. The blades 22 each include a first portion perpendicularly connected to the shaft 21 and a second portion which is perpendicularly connected to a distal end of the first portion. The blades 22 drive the shaft 21 to rotate so as to activate the generator 23 to generate electric power.

A chargeable battery 30 is electrically connected to the generator 23 and the light bulb 11. The electric power generated by the generator 23 is stored in the chargeable battery 30. A circuit board 31 is electrically connected to the chargeable battery 30 and the light bulb 11 so as to provide electric power to the light bulb 11 and controls ON and OFF of the light bulb 11. The circuit board 31 includes an A/D converter 301 which is electrically connected with a charging circuit protection circuit 302. A battery 303 is electrically connected to the charging circuit protection circuit 302 and a DC/DC converter or DC/AC inverter 304 which provides electric power to the light bulb 11.

When the electric power generated by the wind power generator unit 20 is provided to the light bulb 11, the alternative current is transferred into direct current which is stored in the battery 303 which then provides electric power to the light bulb 11.

Besides, the battery 303 is electrically connected to a security-infrared system 306 which is electrically connected to a detection control 307 which is electrically connected to the charging circuit protection circuit 302. The detection control 307 is electrically connected to a signal transmitter on AC unit 308 which is electrically connected to a utility AC source 309 which is electrically connected the DC/DC converter or DC/AC inverter 304.

When the detection control 307 detects that the electric power is below the expected level, the signal is sent to a control center via the signal transmitter on AC unit 308. The utility AC source 309 takes over and provides electric power to the light bulb 11 via the DC/DC converter or DC/AC inverter 304.

The generator 23 is located at a base portion of the post 10 such that the generator 23 does not drop to injure people.

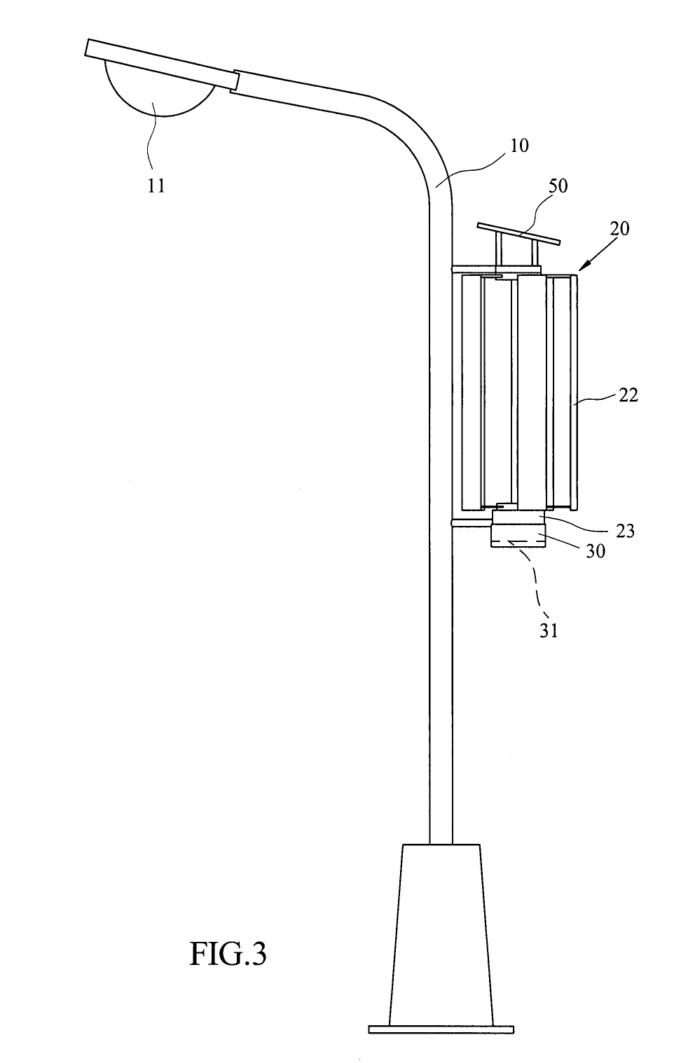

A solar power panel 50 (FIG. 3) is connected to the post 10 and electrically connected to the chargeable battery 30 so as to have another power source besides the wind power.

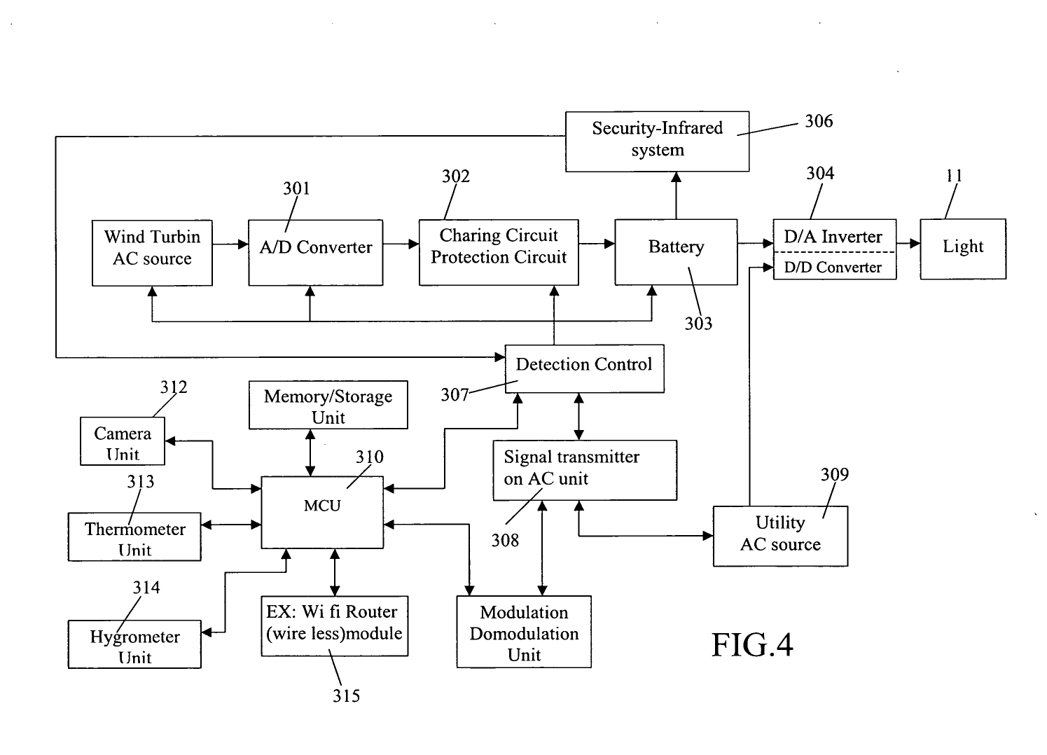

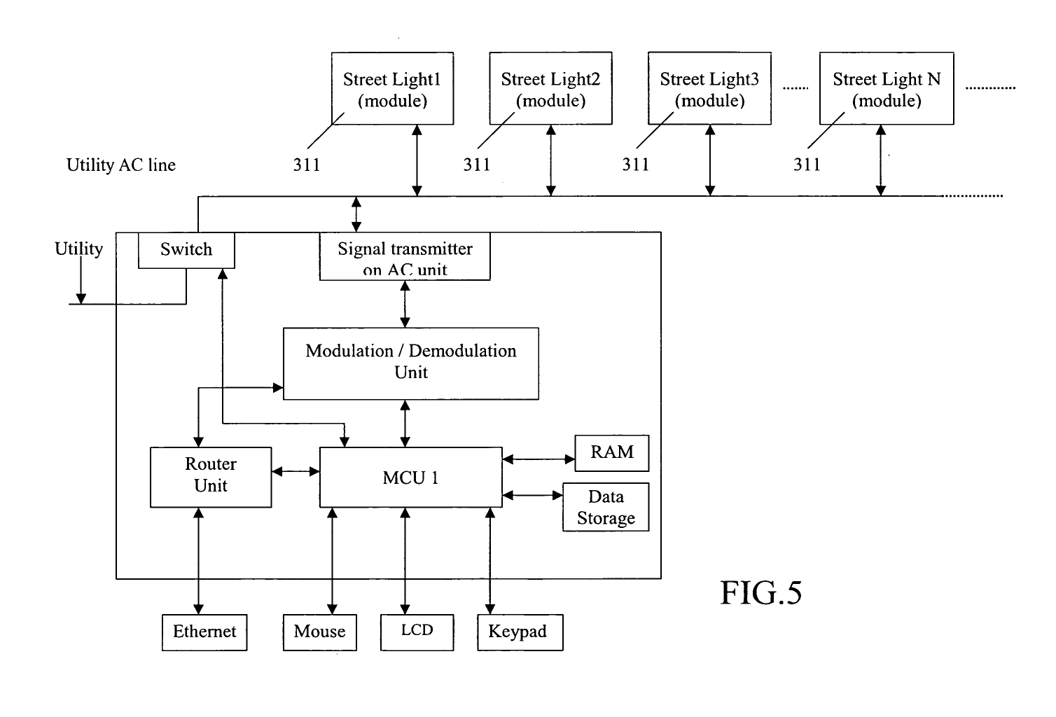

The circuit board 31 is connected with an alarm system which informs a MCU 310 such that when someone tries to climb the post 10, the alarm system informs local police or the MCU 310 via cables as shown in FIGS. 4 and 5.

The MCU 310 monitors the battery 303, revolutions and voltages of the generator 23 and power consuming of each street light module 311 via cables. The contents that the MCU 310 monitors include camera unit 312, thermometer unit 313 and hygrometer unit 314. Each street light module 311 is electrically connected with a WI-FI router module which sends information to the MCU 310.

The wind power generator unit 20 provides another power source instead of the solar power so that the electric power can be stored sufficiently even in nighttime. The blades 22 are T-shaped blades which are activated by different wind directions.

While we have shown and described the embodiment in accordance with the present invention, it should be clear to those skilled in the art that further embodiments may be made without departing from the scope of the present invention.

What is claimed is:

1. A street light comprising:
a post having a light bulb connected to a top thereof;
a wind power generator unit connected to the post and including a shaft, a plurality of blades connected to the shaft and a generator connected to the shaft, and
a chargeable battery electrically connected to the generator and the light bulb, a circuit board electrically connected to the chargeable battery and the light bulb.

2. The street light as claimed in claim 1, wherein a solar power panel is connected to the post and electrically connected to the chargeable battery.

3. The street light as claimed in claim 1, wherein the generator is located at a base portion of the post.

4. The street light as claimed in claim 1, wherein the light bulb is composed of Light Emitting Diodes.

5. The street light as claimed in claim 1, wherein the circuit board includes an A/D converter which is electrically connected with a charging circuit protection circuit, a battery is electrically connected to the charging circuit protection circuit and a DC/DC converter/DC/AC inverter which provides electric power to the light bulb, the battery is electrically connected to a security-infrared system which is electrically connected to a detection control which is electrically connected to the charging circuit protection circuit, the detection control is electrically connected to a signal transmitter on AC unit which is electrically connected to a utility AC source which is electrically connected the DC/DC converter/DC/AC inverter.

6. The street light as claimed in claim 1, wherein the circuit board is connected with an alarm system which informs a MCU, the MCU monitors the battery, revolutions, voltages of the generator, power consuming, camera unit, thermometer unit and hygrometer unit of each street light module, each street light module is electrically connected with a WI-FI router module which sends information to the MCU.
